(19) United States
(12) Patent Application Publication
(10) Pub. No.: US 2012/0018042 A1
(43) Pub. Date: Jan. 26, 2012

(54) VENEER PATCHING APPARATUS

(75) Inventors: Erkki KAURANEN, Kajaani (FI); Esko TOLONEN, Oulu (FI)

(73) Assignee: RAUTE OYJ, Nastola (FI)

(21) Appl. No.: 13/184,774

(22) Filed: Jul. 18, 2011

(30) Foreign Application Priority Data
Jul. 21, 2010 (FI) 20105815

(51) Int. Cl. B27G 1/00; B27D 5/00

(52) U.S. Cl. 144/24.16

(57) ABSTRACT

A veneer patching apparatus for removing defects from a plywood veneer (1) includes a defect removing plunger (5), a punch (6) passed through by the removing plunger (5), a patch plunger (8) passing through the punch in alignment and synchronously operating with the removing plunger, elements for feeding the veneer to be patched between the removing plunger, and the punch and elements for feeding patch veneer (2) between the patch plunger and the punch. The stroke length of the removing plunger extends to the level of the patch veneer, and the feeding of the patch veneer is arranged as a continuous web to be fed during the return stroke. The defect to be removed has been arranged to be removed from the apparatus by pressing the defect spot with the removing plunger into the hole made by the patch plunger in the patch veneer.

The present invention is directed to an apparatus for patching defects smaller than a certain size in a plywood veneer. The patching is based on punching out a defect point with a punch having a predetermined size, and patching the hole with a solid veneer piece with a tight tolerance to be pressed into the hole. Basically, this operation has been performed manually, and later with machines developed for this purpose. These machines usually comprise a stationary patching head, the veneer to be patched being moved in the operating area thereof according to the points to be patched. The patching head comprises the above mentioned punch for punching out the defect point and means for cutting out a patch piece and for punching it directed to the hole that was made.

An apparatus with advanced operations has been described in the patent publication U.S. Pat. No. 2,336,704. This apparatus comprises a veneer patching head including, as a cutting element, a fixed punch with a cutting opening defining the size and shape of the defect point to be punched out from the veneer. This fixed punch is located so that the veneer can be placed onto the punch, the defect point aligned with the cutting hole. Above the punch and the veneer thereon, there is a reciprocating plunger which can press the defect point in to the opening of the punch. The edges of the punch cut the defect point out off the veneer. Located below the opening of the punch there is a slide which reciprocates in the direction of the veneer plane, transversally with respect to the opening of the punch. The slide includes a first opening dimensioned to be slightly larger than the punch opening. The punching motion of the plunger cutting off the defect point is extended to the level of the slide, so that it pushes the defect point cut off from the veneer to the first opening of the slide as it goes through the punch opening. By moving the slide from below the punch to its first extreme position, the defect point can be removed from this first opening of the slide.

The slide in question also has a second opening of the corresponding size, located in the same path of the reciprocal motion of the slide as the first opening. This second opening is provided for collecting a veneer piece intended to be a patch piece from devices dosing these pieces one by one to the slide at the opposite, second extreme position of the slide in its reciprocal motion. The veneer piece intended to be a patch piece placed in the second opening is brought to the punch opening when the slide moves to its first extreme position, above the patch plunger below. The patch plunger pushes the veneer piece against the punch and further as a cut-to-size and shape patching piece through the punch opening, to the corresponding hole that was formed when cutting out the defect in the veneer to be patched. The operation is repeated, and the veneer pieces left over from the patch piece in the second opening of the slide are removed during the fetch-motion of the slide, before feeding a new veneer piece to the opening for the next patch piece.

Concerning this previously known apparatus, an operation delay caused by the reciprocal motion of the slide can be mentioned as functional and structural problems. The delay is increased by a safety time needed for eliminating the possibility of collisions between the slide and the plungers. The operation of the device also requires that the patch pieces supplied to the apparatus must be single pieces that are cut to the proper size and shape. Also effective blowing means are required at the points of removal for removing the veneer pieces from the slide opening.

These problems can be reduced or solved by means of an apparatus according to the present invention. The apparatus comprises, as is known in the art, a defect removing plunger, a punch passed through by the removing plunger, and an aligned patch plunger passing through the punch in alignment and synchronously operating with the removing plunger, means for feeding the veneer to be patched between the removing plunger and a counter piece, and means for feeding patch veneer between the patch plunger and the punch, the removing plunger having a stroke length extending to the plane of the patch veneer. Characteristically of the invention, the defect to be removed has been arranged to be removed from the apparatus by pressing the defect spot with the removing plunger to the hole made by the patch plunger to the patch veneer.

The invention will be described in more detail with reference to the enclosed drawings, wherein,

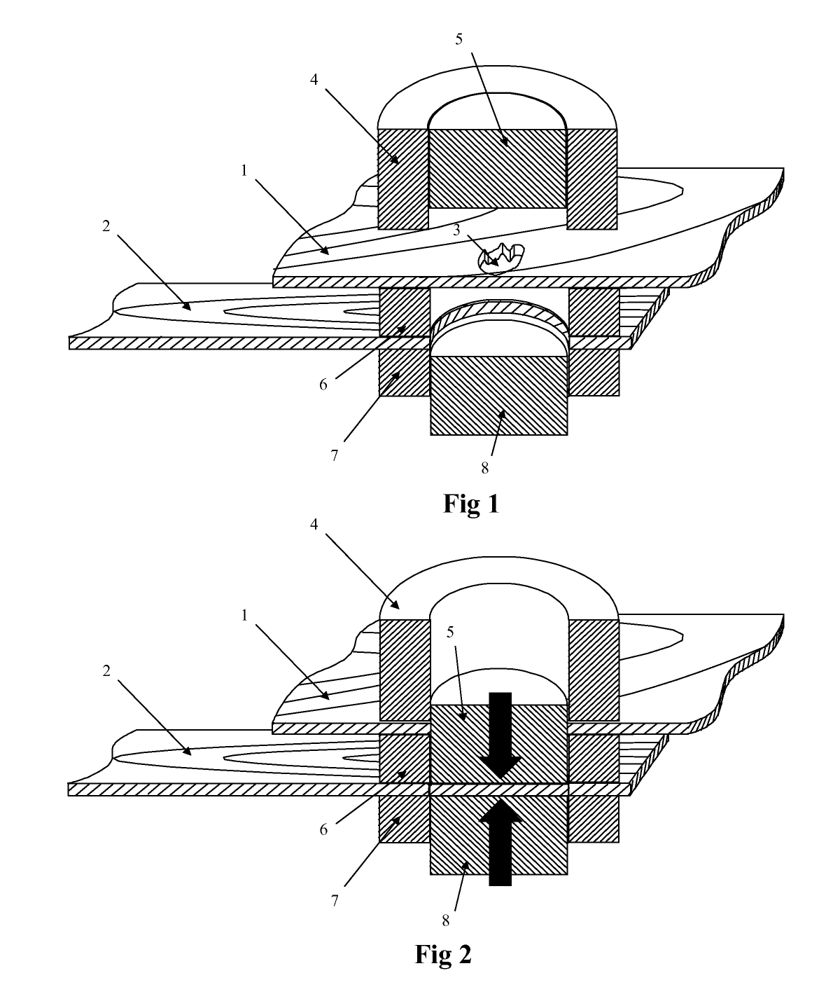

FIG. 1 shows an apparatus according to the present invention in a situation where a defect point in the veneer has been fed to the patching point,

FIG. 2 shows the apparatus in a situation where the defect point has been cut out of the veneer,

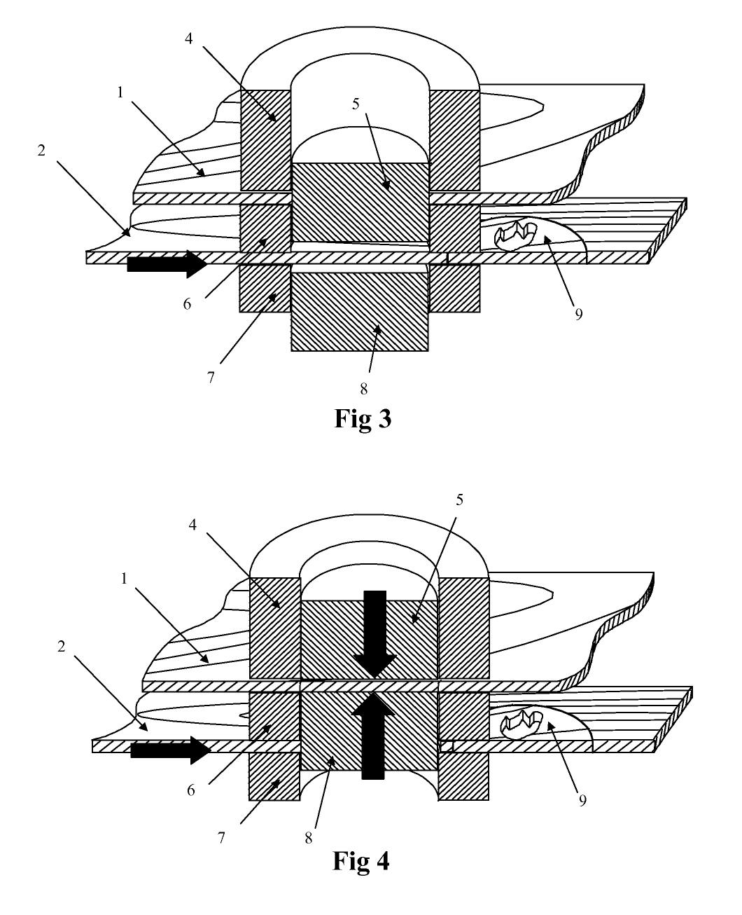

FIG. 3 shows the apparatus in a situation where the patch veneer is fed to the point to be patched, and

FIG. 4 shows the apparatus in a situation where the patch is placed to the point to be patched.

In FIG. 1, veneer 1 to be patched is fed to the patching point of the patching apparatus' patching head so that the detected defect point 3 can be removed from the veneer and the resulting removal point can be mended with solid veneer.

As an essential part, the apparatus comprises a punch 6 having an opening passing through it in a perpendicular orientation to the veneer plane. The punch 6 is a fixed part of the frame of the apparatus. The apparatus comprises two opposite plungers 5 and 8 passing through the opening of the punch cooperating synchronously, the upper plunger 5 meant for removing a defect of the veneer 1 by cutting it out with the edges of the punch opening, and the lower plunger 8, meant for pushing a sound piece of patch veneer cut out from the patch veneer web into this vacant defect point by the punch 6 and the plunger 8. The veneer to be patched is fed between the removing plunger 5 and the punch 6, and the patch veneer is correspondingly fed between the patch plunger 8 and the punch 6. Further, the apparatus comprises a positioning lock 4 for locking the veneer against a counter piece during the patching operation. During the positioning motion of the patch veneer and the veneer to be patched, the positioning lock 4 is in an elevated position.

As shown in FIG. 1, the veneer 1 to be patched has been fed between the punch 6 and the elevated positioning lock 4 so that the defect 3 of the veneer is positioned with the opening of the punch 6 and simultaneously under the removing plunger 5. The plunger 5 is in the posterior position of its working stroke. The patch veneer 2 is correspondingly between the frame 7 and the punch 6, positioned with the patch plunger 8, said plunger also being in the posterior position of its working stroke. The patch veneer 2 is in the form of a continuous web having a width more than the diameter of the opening of the punch 6. As a result from the previous operating cycle, the patch veneer has a hole at the punch opening 6, from which the previous patch veneer piece has been pushed to the veneer 1 above with the plunger 8 during the previous patching cycle.

From the situation of FIG. 1, the operating cycle proceeds so that the locking device 4 is pressed down, thus locking the veneer 1 in place. After this, the removing plunger 5 is driven to its full stroke which extends to the level of the patch veneer 2. During this operation, the defect of the veneer 1 is cut out according to the dimension of the opening of the punch 6 and, pushed by the removing plunger 5, is pressed into the hole of the patch veneer 2, said situation being illustrated in the accompanying FIG. 2. In the next step, the patch veneer 2 is fed one step forward so that a completely sound veneer area comes to the opening of the punch 6. As a result of this feeding motion, the previous portion of the patch veneer is removed from the apparatus and takes the defect veneer piece 3 pushed to its hole along with it. While the patch veneer is being moved, the removing plunger retreats to the upper plane of the veneer 1 to be patched. The patching plunger 8 cuts a sound veneer patch, from the patch veneer, and presses it into the corresponding hole in the veneer 1 with the punch 6, while the removing plunger 5 acts as a counter piece (FIG. 4). The operation is repeated for the next defect to be patched, starting from the situation of FIG. 1.

In machines according to the state of the art, the web used for veneer patching had to be pretreated by cutting it to pieces slightly bigger than the patch, which is a cumbersome work phase and causes waste of raw material. Also, there are functional problems in handling of separate pieces.

The apparatus according to the present invention utilizes a long veneer web, whereby there is no need to leave extra material between the patches. As the defect point cut from the veneer is removed from the apparatus using the patch veneer, less blowing is needed, and the removal of the cut-out defect point is in unison with the feed stroke, whereby the sound veneer web replaces the back-and-forth moving metal slide included in the method of prior art. The veneer web eliminates the risk of breaking components in the event of a malfunction, where the movement of the slide is prevented. In that case, the veneer web is cut without breaking the components of the apparatus.

1. A veneer patching apparatus for removing defects from a plywood veneer (1), said apparatus comprising a defect removing plunger (5), a punch (6) passed through by the removing plunger (5), a patch plunger (8) passing through the punch in alignment and synchronously operating with the removing plunger, means for feeding the veneer to be patched between the removing plunger and the punch, and means for feeding patch veneer (2) between the patch plunger and the punch, said apparatus having a stroke length of the removing plunger which extends to the level of the patch veneer, and the feeding of the patch veneer being arranged as a continuous web to be fed during the return stroke, characterized in that the defect to be removed has been arranged to be removed from the apparatus by pressing the defect spot to the hole made by the patch plunger in the patch veneer with the removing plunger.
